(19) United States
(12) Patent Application Publication
(10) Pub. No.: US 2009/0194897 A1
(43) Pub. Date: Aug. 6, 2009

(54) Injection member of molding machine and molding method

(75) Inventors: Satoshi Sugiyama, Chiba (JP); Hiroyoshi Sumen, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: SUMITOMO HEAVY INDSTRIES LTD., SHINAGAWA-KU (JP)

(21) Appl. No.: 11/631,165

(22) PCT Filed: Jun. 30, 2005
(86) PCT No.: PCT/JP05/12045

§ 371 Date: Dec. 29, 2006

(30) Foreign Application Priority Data
Jun. 30, 2004 (JP) 2004-193398

(51) Int. Cl. B29C 45/77; B29C 45/50

(52) U.S. Cl. 264/40.5; 425/145

(57) ABSTRACT

An injection member of a molding machine is provided which can shorten the molding cycle and maintenance time, and prevent occurrence of galling between a cylinder member and an injection member. The injection member of the molding machine includes a supply section (P1) to which a molding material is supplied via a molding material supply port of the cylinder member, a compression section (P2) for melting and compressing the molding material supplied from the supply section (P1), and a metering section (P3) for metering the molding material supplied from the compression section (P2). The supply section (P1) has a pressure adjustment changeover point (q1) shifted rearward from its front end by a predetermined distance, and is divided at the pressure adjustment changeover point (q1). The pressure of the molding material is gradually reduced in a pressure gradual reduction area (AR1) from the rear end of the supply section (P1) to the pressure adjustment changeover point (q1). The pressure of the molding material is adjusted in a pressure adjustment area (AR2) from the pressure adjustment changeover point (q1) to the front end of the supply section (P1).

### TECHNICAL FIELD

The present invention relates to an injection member of a molding machine and to a molding method.

### BACKGROUND ART

Conventionally, in a molding machine; for example, in an injection molding machine, resin (molding material) heated and melted in a heating cylinder, which serves as a cylinder member, is injected under high pressure and charged into a cavity of a mold apparatus, and the injected resin is cooled and solidified in the cavity, whereby a molded product is obtained.

For such a molding operation, the injection molding machine includes a mold-clamping apparatus and an injection apparatus. The mold-clamping apparatus includes a stationary platen and a movable platen. The movable platen is advanced and retreated by means of a mold-clamping cylinder, whereby a mold apparatus is closed, clamped, and opened.

Meanwhile, the injection apparatus includes a heating cylinder for heating and melting resin fed from a hopper, and an injection nozzle for injecting the molten resin. A screw, which serves as an injection member, is disposed in the heating cylinder in a reciprocative and rotatable condition. When the screw is rotated upon drive of a metering motor, metering of the resin is effected, whereby the resin supplied from the hopper into the heating cylinder is caused to advance along a groove formed on the screw, and is melted during this period. When the screw is then advanced upon drive of an injection motor, the molten resin is injected from the injection nozzle, and charged into the cavity. For such an operation, the screw has a supply section for receiving the resin supplied from the hopper to the heating cylinder, a compression section located forward of the supply section and adapted to compress the resin supplied from the supply section while melting the resin, and a metering section for metering the resin supplied from the compression section so as to inject the resin in a predetermined amount each time. (see, for example, Patent Document 1).

Patent Document 1: Japanese Patent Application Laid-Open (kokai) No. H9-52266.

### DISCLOSURE OF THE INVENTION

### Problems to be Solved by the Invention

However, in the conventional injection apparatus, when the rotational speed of the metering motor is increased so as to rotate the screw at higher speed in an attempt to shorten the molding cycle, the pressure within the heating cylinder at the compression section increases, and the temperature of the resin increases excessively because of shear heating. As a result, the time required to cool the resin charged into the cavity; i.e., cooling time, becomes long, so that the molding cycle cannot be shortened.

In addition, when the temperature of the resin increases excessively, burning of the resin occurs, and foreign matter contaminates molded products. Further, since a burned portion of the resin adheres to the screw, the time required to maintain the screw, or maintenance time, becomes long.

Moreover, as the pressure within the heating cylinder increases, the force with which the screw is pressed against the inner circumferential surface of the heating cylinder increases, whereby galling occurs between the heating cylinder and the screw.

An object of the present invention is to solve the above-mentioned problems in the conventional injection apparatus and to provide an injection member of a molding machine and an injection method which can shorten the molding cycle and maintenance time, and prevent occurrence of galling between a cylinder member and an injection member.

### Means for Solving the Problems

In order to achieve the above object, an injection member of a molding machine according to the present invention comprises a supply section to which a molding material is supplied via a molding material supply port of a cylinder member; a compression section formed forward of the supply section and adapted to melt and compress the molding material supplied from the supply section; and a metering section formed forward of the compression section and adapted to meter the molding material supplied from the compression section.

The supply section has a pressure adjustment changeover point shifted rearward from the front end of the supply section by a predetermined distance, and is divided at the pressure adjustment changeover point. The pressure of the molding material is gradually reduced in a pressure gradual reduction area from the rear end of the supply section to the pressure adjustment changeover point. The pressure of the molding material is adjusted in a pressure adjustment area from the pressure adjustment changeover point to the front end of the supply section.

### EFFECT OF THE INVENTION

According to the present invention, an injection member of a molding machine comprises a supply section to which a molding material is supplied via a molding material supply port of a cylinder member; a compression section formed forward of the supply section and adapted to melt and compress the molding material supplied from the supply section; and a metering section formed forward of the compression section and adapted to meter the molding material supplied from the compression section.

The supply section has a pressure adjustment changeover point shifted rearward from the front end of the supply section by a predetermined distance, and is divided at the pressure adjustment changeover point. The pressure of the molding material is gradually reduced in a pressure gradual reduction area from the rear end of the supply section to the pressure adjustment changeover point. The pressure of the molding material is adjusted in a pressure adjustment area from the pressure adjustment changeover point to the front end of the supply section.

In this case, in the supply section, the pressure of the molding material is gradually reduced in the pressure gradual reduction area from the rear end of the supply section to the pressure adjustment changeover point, and the pressure of the molding material is adjusted in the pressure adjustment area from the pressure adjustment changeover point to the front end of the supply section, whereby the density of the molding material moving forward within the pressure gradual reduction area can be gradually reduced. Accordingly, the pressure within the cylinder member at the compression section is prevented from increasing excessively.

As a result, the temperature of the molding material is prevented from increasing excessively because of shear heating, whereby the cooling time of the molding material charged into a cavity can be shortened, and thus, the molding cycle can be shortened.

In addition, since the temperature of the molding material can be prevented from increasing excessively, burning of the molding material does not occur, and molded products are not contaminated by foreign matter. Further, since a burned portion of the molding material does not adhere to the injection member, the maintenance time for maintaining the injection member can be shortened.

Moreover, since the pressure within the cylinder member is prevented from increasing, the force with which the injection member is pressed against the inner circumferential surface of the cylinder member does not increase, whereby occurrence of galling between the cylinder member and the injection member can be prevented.

Since the pressure of the molding material is adjusted in the pressure adjustment area, the molding material can be stably fed to the compression section.

### BRIEF DESCRIPTION OF DRAWINGS

FIG. 1 is a schematic view of a main body portion of a screw according to a first embodiment of the present invention.

FIG. 2 is a conceptual view of an injection apparatus according to the first embodiment of the present invention.

FIG. 3 is a schematic view of a main body portion of a screw according to a second embodiment of the present invention.

FIG. 4 is a first view showing a kneading area in a third embodiment of the present invention.

FIG. 5 is a second view showing the kneading area in the third embodiment of the present invention.

FIG. 6 is a third view showing the kneading area in the third embodiment of the present invention.

### DESCRIPTION OF SYMBOLS

11: heating cylinder
14: screw
23: flight
24: groove
25: resin supply port
34: sub-flight
AR1: pressure gradual reduction area
AR2: pressure adjustment area
AR4: kneading area
P1: supply section
P2: compression section
P3: metering section
q1: pressure adjustment changeover point

### BEST MODE FOR CARRYING OUT THE INVENTION

The embodiments of the present invention will next be described in detail with reference to the drawings. Here, an injection molding machine, which is an example molding machine, will be described.

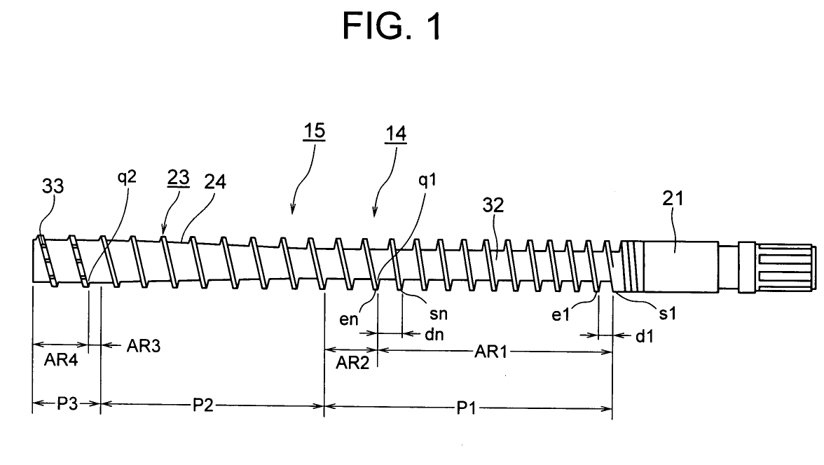

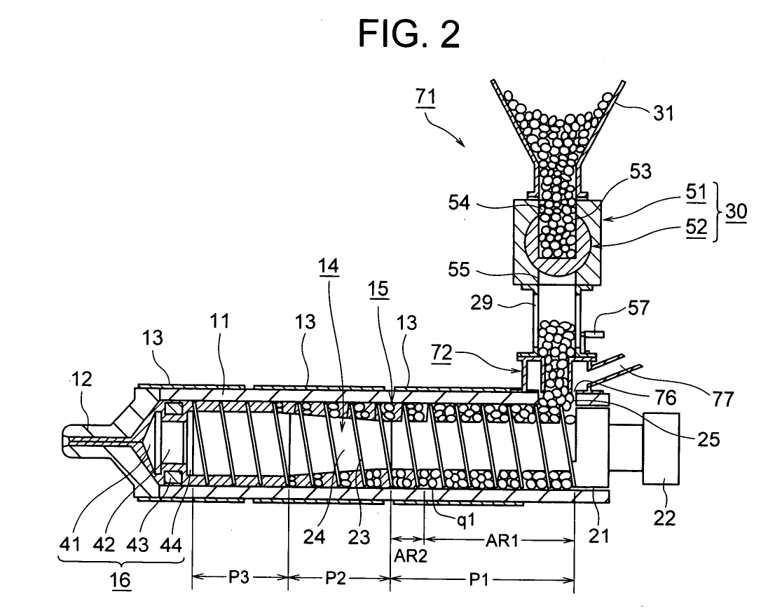

FIG. 1 is a schematic view of a main body portion of a screw according to a first embodiment of the present invention, and FIG. 2 is a conceptual view of an injection apparatus according to the first embodiment of the present invention.

In these drawings, reference numeral 11 denotes a heating cylinder, which serves as a cylinder member. An injection nozzle 12 is attached to the front end (the left end in FIG. 2) of the heating cylinder 11, and a plurality of annular heaters 13, serving as heating members, are disposed on the periphery of the heating cylinder 11. A screw 14, which serves as an injection member, is disposed within the heating cylinder 11 such that the screw 14 can rotate and can advance and retreat (move in the left-right direction in FIG. 2). The screw 14 is composed of a main body portion 15, which constitutes the main body of the screw 14, and a head portion 16. The screw 14 is connected at its rear end (the right end in FIG. 2) to a drive apparatus 22 via a shaft portion 21. The drive apparatus 22 is composed of an unillustrated metering motor, serving as a drive portion for metering, and an unillustrated injection motor, serving as a drive portion for injection. A flight 23 is formed around the main body portion 15 by a continuous spiral projection, and a groove 24 is formed by the flight 23.

The head portion 16 is composed of a conical screw head 41; a rod 42 connecting the screw head 41 and the main body portion 15; an annular check ring 43 disposed around the rod 42; and a seal ring 44 disposed for engagement with the check ring 43 and attached to the main body portion 15. The check ring 43 and the seal ring 44 serve as reverse-flow prevention means for permitting, during a metering step, resin (molding material), which has been melted at the main body portion 15, to flow forward (leftward in FIG. 2) of the screw head 41, and for preventing the resin accumulated forward of the screw head 41 from flowing in reverse during an injection step.

A resin supply port 25, serving as a molding material supply port, is formed in the heating cylinder 11 at a predetermined position near the rear end thereof. A resin supply apparatus 71, serving as a molding-material supply apparatus, is disposed at the resin supply port 25. The resin supply apparatus 71 is composed of a cylindrical storage pipe 29, a cylindrical gas evacuation portion 72, a resin feeder 30, serving as a molding-material feeder, and a funnel-shaped hopper 31. The storage pipe 29 is disposed such that it faces the resin supply port 25 and communicates with the interior of the heating cylinder 11 via the resin supply port 25, and is adapted to store resin. The gas evacuation portion 72 is connected to the lower end of the storage pipe 29, and has a double tube structure. The resin feeder 30 is connected to the upper end of the storage pipe 29, and is adapted to supply a predetermined amount of resin to the storage pipe 29. The hopper 31 is disposed above the resin feeder 30 and connected to the upper end of the resin feeder 30. Resin in the form of pellets is stored in the hopper 31 and is supplied to the interior of the heating cylinder 11 via the resin supply port 25.

The resin feeder 30 is composed of a casing 51, and a valve 52 rotatably disposed in the casing 51. A resin inlet 54, serving as a molding-material inlet, is formed in an upper end portion of the casing 51, and a resin outlet 55, serving as a molding-material outlet, is formed in a lower end portion of the casing 51. A pocket 53 is formed in the valve 52. Further, a level sensor 57 is disposed on the storage pipe 29 at a predetermined vertical position; in the present embodiment, at a lower portion of the storage pipe 29. The level sensor 57 detects the level (the height of the upper end) of resin within the storage pipe 29, and sends a detection signal to an unillustrated control apparatus. Upon receipt of the detection signal, the control apparatus determines whether or not a predetermined amount of resin is stored within the storage pipe 29. When the amount of the resin stored within the storage pipe 29 decreases, an unillustrated resin supply motor, serving as a drive portion for resin supply, is driven so as to rotate the valve 52 to thereby selectively establish communication between the pocket 53 and the resin inlet 54 or communication between the pocket 53 and the resin outlet 55, whereby the resin within the hopper 31 is supplied to the pocket 53, and the resin within the pocket 53 is supplied to the storage pipe 29 via a resin passage within the gas evacuation portion 72. The resin stored in the storage pipe 29 is supplied to the interior of the heating cylinder 11 via the resin supply port 25.

The resin supply port 25 is formed at a location such that the resin supply port 25 faces a rear end portion (a right end portion in FIG. 2) of the groove 24 when the screw 14 is positioned at the fowardmost position within the heating cylinder 11. The main body portion 15 has a supply section P1, a compression section P2, and a metering section P3 formed in this sequence from the rear end (right end in FIG. 2) to the front end. The supply section P1 receives the resin supplied via the resin supply port 25. The compression section P2 compresses the resin supplied from the supply section P1 while melting the resin. The metering section P3 meters the resin supplied from the compression section P2 so as to inject the resin in a predetermined amount each time. Notably, the metering section P3 accounts for about 5% to 20% of the entire length of the main body portion 15.

In the injection apparatus having the above-described configuration, in a metering step, the screw 14 is rotated through drive of the metering motor, and is retreated (moved rightward in FIG. 2) with the rotation. Thus, the resin supplied into the heating cylinder 11 by means of the resin supply apparatus 71 is caused to advance (move leftward in FIG. 2) along the groove 24, and is heated and melted by means of the heaters 13. Since the check ring 43 moves forward in relation to the rod 42 as the screw 14 is retreated, the resin having reached the front end of the main body portion 15 passes through a resin passage between the rod 42 and the check ring 43, and reaches a space located forward of the screw head 41. Accordingly, an amount of molten resin corresponding to a single shot is accumulated forward of the screw head 41.

Subsequently, in an injection step, the screw 14 is advanced through drive of the injection motor, whereby the resin accumulated forward of the screw head 41 is injected from the injection nozzle 12, and is charged into a cavity of an unillustrated mold apparatus.

Notably, in the metering step, gas is generated as the resin is heated and melted. If resin containing gas is charged into the cavity, the quality of a molded product lowers because of voids, resin burning, or the like. In view of this, an annular slit 76 is formed in the gas evacuation portion 72, and gas in the heating cylinder 11 and the storage pipe 29 is evacuated via the slit 76. The evacuated gas is fed to an unillustrated vacuum source via a connection pipe 77.

Incidentally, in the injection apparatus having the above-described configuration, in order to shorten the molding cycle, the rotational speed of the metering motor is increased so as to rotate the screw 14 at higher speed. In this case, the pressure within the heating cylinder 11 at the compression section P2 increases, and the temperature of the resin increases excessively because of shear heating. As a result, the cooling time of the resin charged into the cavity becomes long, so that the molding cycle cannot be shortened.

In addition, when the temperature of the resin increases excessively, burning of the resin occurs, and foreign matter contaminates molded products. Further, since a burned portion of the resin adheres to the screw 14, the maintenance time for maintaining the screw 14 becomes long.

Moreover, as the pressure within the heating cylinder 11 increases, the force with which the screw 14 is pressed against the inner circumferential surface of the heating cylinder 11 increases, whereby galling occurs between the heating cylinder 11 and the screw 14.

In order to overcome these drawbacks, in the present embodiment, a point shifted rearward from the front end of the supply section P1 by a predetermined distance is set as a pressure adjustment changeover point q1; and the supply section P1 is divided at the pressure adjustment changeover point q1 such that an area between the rear end of the supply section P1 and the pressure adjustment changeover point q1 serves as a pressure gradual reduction area AR1 (first area), and an area between the pressure adjustment changeover point q1 and the front end of the supply section P1 serves as a pressure adjustment area AR2 (second area). In the present embodiment, the pressure gradual reduction area AR1 extends over a distance corresponding to 80% to 95% of the length of the supply section P1, and the pressure adjustment area AR2 extends over a distance corresponding to 5% to 20% of the length of the supply section P1.

In the pressure gradual reduction area AR1, the volume of each section corresponding to each lead of the flight 23 is increased stepwise from the rear end of the supply section P1 to the pressure adjustment changeover point q1. That is, in the pressure gradual reduction area AR1, the sections from the rear end to the front end have different lead lengths di (i=1, 2, . . . , n) gradually increasing from the rear end to the front end. Further, in the pressure gradual reduction area AR1, the groove 24 has a constant depth, whereby a shaft portion 32 of the screw 14 defined by the bottom of the groove 24 has a constant outer diameter.

The volume Qb of the groove 24 in a section corresponding to a single lead of the flight 23 and extending forward from the rear end of the supply section P1 and the volume Qf of the groove 24 in a section corresponding to a single lead of the flight 23 and extending rearward from the pressure adjustment changeover point q1 are set such that the following inequalities are satisfied:

Qf>Qb

1.05≦ε≦2.00

where ε is the ratio (volume ratio) of the volume Qf to the volume Qb (ε=Qf/Qb).

In this case, the volume Qb can be calculated by means of integrating the cross sectional area of the groove 24 from the rear end of the supply section P1, which is a calculation start point s1, to a point shifted forward from the rear end of the supply section P1 by a distance corresponding to a single lead, which point is a calculation end point e1. Alternatively, the volume Qb can be calculated by multiplying the cross sectional area at a predetermined point; e.g., an intermediate point, between the calculation start point s1 and the calculation end point e1 by a distance between the calculation start point s1 and the calculation end point e1 (a length corresponding to a single lead); i.e., a lead length d1. Similarly, the volume Qf can be calculated by means of integrating the cross sectional area of the groove 24 from a point shifted rearward from the pressure adjustment changeover point q1 by a distance corresponding to a single lead, which point is a calculation start point sn, to the pressure adjustment changeover point q1, which is a calculation end point en. Alternatively, the volume Qf can be calculated by multiplying the cross sectional area at a predetermined point; e.g., an intermediate point, between the calculation start point sn and the calculation end point en by a lead length dn.

Meanwhile, in the pressure adjustment area AR2, the volume of each section corresponding to each lead of the flight 23 is maintained constant from the pressure adjustment changeover point q1 to the front end of the supply section P1. That is, the lead length dj is made equal to the lead length dn and maintained constant from the rear end to the front end of the pressure adjustment area AR2. Further, in the pressure adjustment area AR2, the groove 24 has a constant depth, whereby the shaft portion 32 of the screw 14 defined by the bottom of the groove 24 has a constant outer diameter.

Notably, the flight 23 is machined by means of a cutter of a machine tool which machines the screw 14. Every time the screw 14 is machined over a distance corresponding to a single lead, the angle of the cutter is changed so as to change the machining angle, whereby the pitch of the flight 23 is changed stepwise at intervals corresponding to a single lead.

As described above, in the pressure gradual reduction area AR1, the volume of each section corresponding to each lead of the flight 23 is gradually increased from the rear end of the supply section P1 to the pressure adjustment changeover point q1, and the volume ratio ε is set to be larger than 1. Therefore, the density of resin moving forward within the pressure gradual reduction area AR1 can be decreased gradually. Accordingly, the pressure within the heating cylinder 11 at the compression section P2 can be prevented from increasing excessively.

As a result, the temperature of the resin is prevented from increasing excessively because of shear heating, whereby the cooling time of the resin charged into the cavity can be shortened, and thus, the molding cycle can be shortened. Moreover, since the amount of gas generated from the resin can be reduced, the mold apparatus can be prevented from soiling. Accordingly, maintenance of the mold apparatus can be easily performed.

In addition, since the temperature of the resin can be prevented from increasing excessively, burning of the resin does not occur, and molded products are not contaminated by foreign matter. Further, since a burned portion of the resin does not adhere to the screw 14, the maintenance time for maintaining the screw 14 can be shortened.

Moreover, since the pressure within the heating cylinder 11 is prevented from increasing, the force with which the screw 14 is pressed against the inner circumferential surface of the heating cylinder 11 does not increase. Accordingly, it is possible to prevent occurrence of galling between the heating cylinder 11 and the screw 14.

When the resin whose density has been lowered in the pressure gradual reduction area AR1 enters the pressure adjustment area AR2 in which the volume of the groove 24 in each section corresponding to each lead of the flight 23 is maintained constant from the pressure adjustment changeover point q1 to the front end of the supply section P1, the pressure of the resin is adjusted, whereby the density of the resin can be made uniform. Thus, the resin can be fed to the compression section P2 consistently.

The resin fed to the compression section P2 is compressed while being melted at the compression section P2. At the compression section P2, the volume of the groove 24 in each section corresponding to each lead of the flight 23 is decreased gradually from the rear end to the front end of the compression section P2. That is, the depth of the groove 24 is decreased gradually from the rear end to the front end of the compression section P2, whereby the outer diameter of the shaft portion 32 is increased gradually. Moreover, at the compression section P2, the lead length dp2 is made equal to the lead length dn of the pressure gradual reduction area AR1, and maintained constant.

As described above, at the compression section P2, the volume of the groove 24 in each section corresponding to each lead of the flight 23 is decreased gradually. Accordingly, the resin can be compressed while being melted sufficiently, and can be fed to the metering section P3 consistently. In addition, since the temperature of the resin does not increase excessively at the compression section P2, the resin having a proper temperature can be fed to the metering section P3.

The molten resin fed to the metering section P3 is metered at the metering section P3 so as to be injected in a predetermined amount in each cycle. At the metering section P3, the volume of the groove 24 in each section corresponding to each lead of the flight 23 is maintained constant from the rear end to the front end. That is, the depth of the groove 24 is maintained constant from the rear end to the front end of the metering section P3, whereby the outer diameter of the shaft portion 32 is maintained constant. Moreover, at the metering section P3, the lead length dp3 is made equal to the lead length dn of the pressure gradual reduction area AR1; i.e., is maintained constant.

At the compression section P2, the pressure within the heating cylinder 11 is prevented from increasing excessively. However, at the metering section P3, it becomes impossible to knead the resin sufficiently. In order to solve this problem, a point shifted rearward from the front end of the metering section P3 by a predetermined distance is set as a kneading adjustment start point q2; and the metering section P3 is divided at the kneading adjustment changeover point q2 such that an area between the rear end of the metering section P3 and the kneading adjustment start point q2 serves as an ordinary metering area AR3 (first area), and an area between the kneading adjustment start point q2 and the front end of the metering section P3 serves as a kneading area AR4 (second area). In the present embodiment, the ordinary metering area AR3 extends over a distance less than 50% of the length of the metering section P3, and the kneading area AR4 extends over a distance equal to or greater than 50% of the length of the metering section P3.

In the kneading area AR4, a plurality of cuts 33 for kneading are formed along the peripheral edge of the flight 23 at predetermined intervals. The cuts 33, serving as a kneading portion, are formed to axially extend and pass through the flight 23.

Accordingly, the molten resin is caused to advance along the groove 24, pass through the cuts 33, and move to a rearward portion of the groove 24. As a result, the resin is circulated between the two portions of the groove 24 sandwiching the portion of the flight 23 where the cuts 33 are formed, whereby the resin can be kneaded sufficiently.

As described above, since the resin fed from the compression section P2 is kneaded in the kneading area AR4, a low-temperature resin having melted at a proper temperature and having been kneaded sufficiently can be prepared and accumulated forward of the screw head 41.

In the present embodiment, in the pressure gradual reduction area AR1, the lead length di is increased gradually from the rear end to the front end, the depth of the groove 24 is maintained constant, and the shaft portion 32 of the screw 14 defined by the bottom of the groove 24 has a constant outer diameter. However, in the pressure gradual reduction area AR1, the lead length di may be maintained constant from the rear end to the front end, with the depth of the groove 24 increasing gradually so as to gradually reduce the outer diameter of the shaft portion 32.

In the present embodiment, as described above, in order to remove gas generated from the resin in the metering step, the annular slit 76 is formed in the gas evacuation portion 72, and gas within the heating cylinder 11 and the storage pipe 29 is evacuated via the slit 76. However, instead of disposing the gas evacuation portion 72 for active gas evacuation, passive gas evacuation may be performed; that is, the gas may be allowed to flow upward via the hopper 31.

In this case, the gas is generated mainly at the compression section P2 and is fed rearward. Since the density of the resin at the supply section P1 is lowered as described above, the gas can be smoothly fed to the rear.

Next, there will be described a second embodiment of the present invention which is configured to smoothly separate gas from molten resin and feed the gas rearward more smoothly. Notably, components having the same structures as those in the first embodiment are denoted by the same reference numerals, and their repeated descriptions are omitted. For the effect that the second embodiment yields through employment of the same structure, the description of the effect of the first embodiment is incorporated herein by reference.

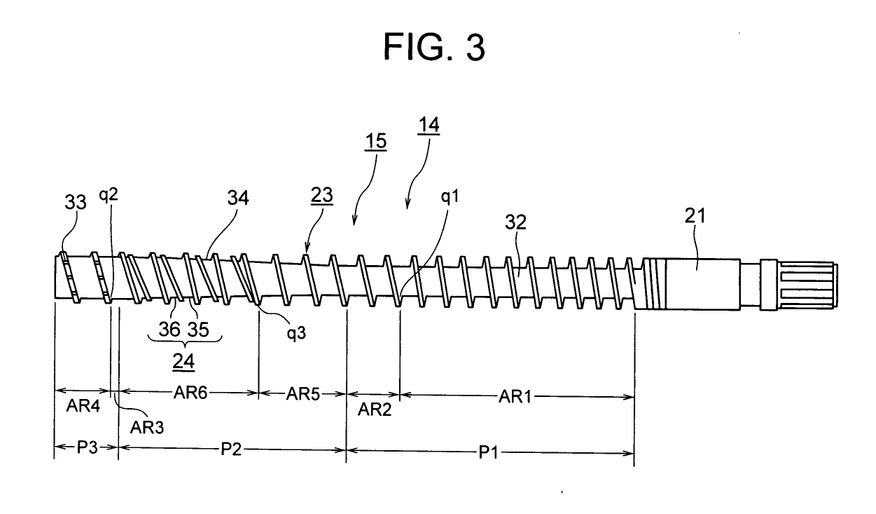

FIG. 3 is a schematic view of a main body portion of a screw according to the second embodiment of the present invention.

In this case, a point shifted rearward (rightward in FIG. 3) from the front end (the left end in FIG. 3) of the compression section P2 by a predetermined distance is set as a degassing adjustment start point q3; and the compression section P2 is divided at the degassing adjustment start point q3 such that an area between the rear end (the right end in FIG. 3) of the compression section P2 and the degassing adjustment start point q3 serves as an ordinary compression area AR5 (first area), and an area between the degassing adjustment start point q3 and the front end of the compression section P2 serves as a degassing adjustment area AR6 (second area). In the present embodiment, the degassing adjustment area AR6 is formed in a region where mechanical energy and heat energy are applied to unillustrated resin (molding material), and a portion of the resin is in a solid state and the remaining portion thereof is in a liquid state. Further, the ordinary compression area AR5 extends over a distance less than 50% of the length of the compression section P2, and the degassing adjustment area AR6 extends over a distance equal to or greater than 50% of the length of the compression section P2. However, the entire compression section P2 may be used as the degassing adjustment area AR6.

In the degassing adjustment area AR6, in addition to the flight 23, a sub-flight 34, serving as a degassing adjustment member, is formed by means of a spiral, continuous projection. The sub-flight 34 has a constant lead length dm, which is greater than the lead length dp2 of the compression section P2, and the sub-flight 34 has an outer diameter smaller than that of the flight 23.

Incidentally, the sub-flight 34 is in contact with the front side surface of the flight 23 at the degassing adjustment start point q3, and the separation from the front side surface of the flight 23 gradually increases from the degassing adjustment start point q3 to the front end of the compression section P2, and comes into contact with the rear side surface of the flight 23 at the front end of the compression section P2. That is, the sub-flight 34 extends so as to divide the groove 24 to thereby form a first groove portion 35 between the front side surface of the flight 23 and the rear side surface of the sub-flight 34, and a second groove portion 36 between the rear side surface of the flight 23 and the front side surface of the sub-flight 34. The cross sectional area of the first groove portion 35 gradually increases from the degassing adjustment start point q3 to the front end of the compression section P2. The cross sectional area of the second groove portion 36 gradually decreases from the degassing adjustment start point q3 to the front end of the compression section P2.

Accordingly, as the second groove portion 36 gradually narrows, the pressure gradient of the resin in the degassing adjustment area AR6 increases, so that the gas generated from the resin that is caused to advance (move leftward in FIG. 3) within the groove 24 is separated from the sufficiently melted resin. As a result, the gas can be smoothly separated from the molten resin, and the gas can be fed rearward more smoothly.

Notably, a sufficiently melted portion of the resin caused to advance within the groove 24 easily flows over the sub-flight 34 and is caused to advance along the first groove portion 35, and a resin portion not melted sufficiently is prevented from advancing as the second groove portion 36 gradually narrows. When the resin flows over the sub-flight 34, shear force acts on the resin, so that the resin is melted more sufficiently, and is kneaded preliminarily.

Next, a third embodiment of the present invention will be described.

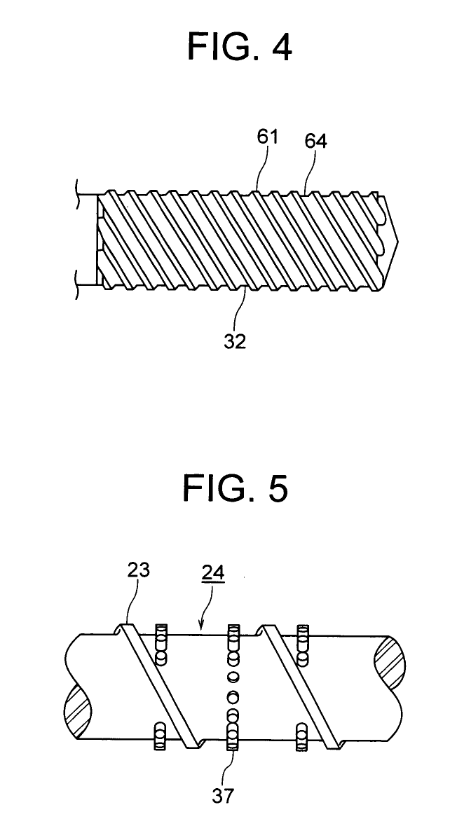

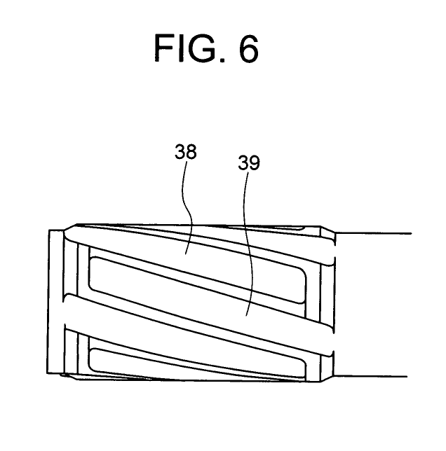

FIG. 4 is a first view showing a kneading area in the third embodiment of the present invention. FIG. 5 is a second view showing the kneading area in the third embodiment of the present invention. FIG. 6 is a third view showing the kneading area in the third embodiment of the present invention.

In FIG. 4, in place of the flight 23, a kneading flight 61, serving as a kneading portion, is formed in the kneading area AR4 (FIG. 3), serving as a second area. The kneading flight 61 is formed by means of a spiral, continuous projection. The kneading flight 61 has a lead length dw, which is smaller than the lead length dp3 of the flight 23 in the ordinary metering area AR3 (first area) and the lead length dp2 of the flight 23 at the compression section P2. Notably, reference numeral 64 denotes a groove formed along the kneading flight 61.

In FIG. 5, in the kneading area AR4, a plurality of projections 37, serving as a kneading portion, are formed at predetermined intervals in the circumferential direction of the groove 24. In FIG. 6, in the kneading area AR4, a Maddock-type kneading portion is formed to extend from the front end (left end in FIG. 6) to the rear end (right end in FIG. 6). This kneading portion is composed of first and second projections 38 and 39 formed with a predetermined angle with respect to the axial direction. The first and second projections 38 and 39 are formed parallel to each other such that clearances remain at the front and rear ends alternately.

The present invention is not limited to the above-described embodiments. Numerous modifications and variations of the present invention are possible in light of the spirit of the present invention, and they are not excluded from the scope of the present invention.

### INDUSTRIAL APPLICABILITY

The present invention is applicable to injection molding machines for producing molded products.

1. An injection member of a molding machine, characterized by comprising:
(a) a supply section to which a molding material is supplied via a molding material supply port of a cylinder member;
(b) a compression section formed forward of the supply section and adapted to melt and compress the molding material supplied from the supply section; and
(c) a metering section formed forward of the compression section and adapted to meter the molding material supplied from the compression section, wherein
(d) the supply section has a pressure adjustment changeover point shifted rearward from the front end of the supply section by a predetermined distance, and is divided at the pressure adjustment changeover point;
(e) the pressure of the molding material is gradually reduced in a pressure gradual reduction area from the rear end of the supply section to the pressure adjustment changeover point; and
(f) the pressure of the molding material is adjusted in a pressure adjustment area from the pressure adjustment changeover point to the front end of the supply section.

2. An injection member of a molding machine according to claim 1, wherein a volume Qb of a groove in a section corresponding to a single lead of a flight and extending forward from the rear end of the supply section and a volume Qf of the groove in a section corresponding to a single lead of the flight and extending rearward from the pressure adjustment changeover point are set such that Qf>Qb.

3. An injection member of a molding machine according to claim 2, wherein a volume ratio F of the volume Qf to the volume Qb is set to satisfy 1.05≦ε≦2.00.

4. An injection member of a molding machine according to claim 2, wherein the volumes Qb and Qf are made different from each other by means of the lead length of the flight.

5. An injection member of a molding machine according to claim 2, wherein the volumes Qb and Qf are made different from each other by means of the depth of the groove.

6. An injection member of a molding machine according to claim 1, wherein a kneading area is formed at the metering section.

7. An injection member of a molding machine according to claim 1, wherein a sub-flight having a predetermined lead length is formed at the compression section.

8. A molding method in which metering is performed by use of an injection member including a supply section to which a molding material is supplied via a molding material supply port of a cylinder member, a compression section formed forward of the supply section and adapted to melt and compress the molding material supplied from the supply section, and a metering section formed forward of the compression section and adapted to meter the molding material supplied from the compression section, wherein the supply section has a pressure adjustment changeover point shifted rearward from the front end of the supply section by a predetermined distance, and is divided at the pressure adjustment changeover point, the method being characterized in that
(a) the pressure of the molding material is gradually reduced in a pressure gradual reduction area from the rear end of the supply section to the pressure adjustment changeover point; and
(b) the pressure of the molding material is adjusted in a pressure adjustment area from the pressure adjustment changeover point to the front end of the supply section.
